(19) United States
(12) Patent Application Publication
(10) Pub. No.: US 2021/0396064 A1
(43) Pub. Date: Dec. 23, 2021

(54) METHOD FOR THE OPERATION OF A MOTORIZED FLAP ARRANGEMENT OF A MOTOR VEHICLE

(71) Applicant: Brose Fahrzeugteile SE & Co. Kommanditgesellschaft, Bamberg, Bamberg (DE)

(72) Inventors: Bernd HERTHAN, Michelau (DE); Sebastian SCHÖDEL, Eckersdorf (DE); Robert DICK, Gundelsheim (DE)

(73) Assignee: Brose Fahrzeugteile SE & Co. Kommanditgesellschaft, Bamberg, Bamberg (DE)

(21) Appl. No.: 17/288,736

(22) PCT Filed: Oct. 24, 2019
(86) PCT No.: PCT/EP2019/079053

§ 371 Date: Aug. 4, 2021

(30) Foreign Application Priority Data
Oct. 26, 2018 (DE) 10 2018 126 838.6

(51) Int. Cl. E05F 15/70; E05F 15/622; G08B 5/22

(52) U.S. Cl. CPC E05F 15/70; E05F 15/622; G08B 5/22; E05Y 2201/434; E05Y 2201/702; E05Y 2400/41; E05Y 2900/546; E05Y 2400/52; E05Y 2201/218; E05Y 2201/234; E05Y 2201/246; E05Y 2400/818; E05Y 2400/44

(57) ABSTRACT

A method for the operation of a motorized flap arrangement of a motor vehicle, wherein the flap arrangement has a flap which is pivotable with respect to a motor vehicle body, wherein the flap arrangement has a back-driveable drive arrangement for the motorized adjustment of the flap and a control arrangement for controlling the drive arrangement. It is proposed that an, in particular gravitationally induced, predetermined flap deflection is detected by means of the control arrangement from a de-energized intermediate position of the flap in a monitoring routine and, in response to the detection of the predetermined flap deflection, a holding routine is triggered in which the drive arrangement is adjusted to a flap-holding position in a holding control circuit.

### CROSS-REFERENCE TO RELATED APPLICATIONS

This application is the U.S. National Phase of PCT Application No. PCT/EP2019/079053 filed on Oct. 24, 2019, which claims priority to German Patent Application No. DE 10 2018 126 838.6, filed on Oct. 26, 2018, the disclosures of which are hereby incorporated in their entirety by reference herein.

### TECHNICAL FIELD

The present disclosure relates to a motorized flap arrangement of a motor vehicle and a method of operating the same.

### BACKGROUND

The motorized adjustment of pivotable flaps of motor vehicles is an important comfort function today. For user acceptance, it is important that secondary functions such as safe holding of the flap in intermediate positions are solved satisfactorily. Especially in the case of a tailgate pivoting around a horizontal axis, lowering of the tailgate caused by gravity regularly results from a deenergized intermediate position if the assigned drive arrangement is designed for a restoring drive capability. This undesirable adjustment movement can be prevented, for example, by a mechanical brake.

### SUMMARY

The present disclosure may be based on one or more problems of designing and developing a method of operating a motorized flap in such a way that the complexity for holding the flap in deenergized intermediate positions is reduced.

According to one or more embodiments, the method may be triggered in the event of a flap deflection from a deenergized intermediate position of the flap, such as caused by gravity, it is first detected from this whether it is a predetermined flap deflection which requires holding. If so, a holding control circuit is activated, which leads to corresponding control of the reversible drive arrangement.

The term “intermediate position” is to be understood broadly here and includes any position of the flap in which the flap has been pivoted away from the closed position, i.e. the permanently closed position of the flap. In that regard, this term also includes the open position of the flap, i.e. the permanently open position of the flap.

The term “deenergized intermediate position” means that the flap is in the intermediate position, while the drive arrangement is deenergized. The deenergized intermediate position may be a static intermediate position in which the flap is stationary.

The term “reversible drive arrangement” means that the drive train of the deenergized drive arrangement can be driven in the reverse direction by a manual adjustment of the flap. A necessary prerequisite for this is the non-self-locking design of the transmission components of the drive train of the drive arrangement.

In one or more embodiments, during a monitoring routine, a predetermined flap deflection from a deenergized intermediate position of the flap, such caused by gravity, is detected by means of the control arrangement, and on detection of the predetermined flap deflection a holding routine is triggered, in which the drive arrangement is controlled to a holding flap position in a holding control circuit by corresponding energization. This therefore corresponds to positional control of the flap.

It may be possible to ensure that the flap is held in intermediate positions without the need for additional mechanical measures. Due to the fact that a holding control circuit with suitable feedback is provided, an automatic reaction is possible to any environmental conditions, a possible inclined position of the motor vehicle. The changing force relationships mentioned above no longer play a significant role.

The drive arrangement may include a single drive with a drive motor or two drives with one drive motor each. In the latter case, it may be provided in a variant that only one of the two drives is controlled to the holding flap position. This may be appropriate if the system friction which is yet to be explained is correspondingly large.

The holding flap position may be in the intermediate position from which the flap is deflected. For this purpose, it is necessary that when it is taken up the intermediate position is stored in a manner suitable for control purposes. Alternatively, it may also be provided that the holding flap position is the deflected flap position. This is appropriate, as it will frequently be sufficient to maintain the deflected position of the flap.

One or more embodiments, for the definition of the predetermined flap deflection may include on how the flap deflection is to be detected, a limit value for the flap displacement, the flap speed or the flap acceleration can be useful here.

According to one or more embodiments, a number of variants for detecting the flap deflection may be used, namely monitoring the generator voltage of a drive motor of the drive arrangement and monitoring the sensor signal of a sensor associated with the drive arrangement. Monitoring of the generator voltage may be advantageous if there is no sensor for detecting a flap movement.

In one or more embodiments, the controlled variable of the holding control circuit is the electric voltage and/or the electric current of at least one drive motor of the drive arrangement. On the one hand, it may be provided that the level of the relevant electrical variable is varied according to the control strategy. On the other hand, alternatively, a variation of pulse width and pulse rate may be provided, provided that the electrical variables concerned are pulse-width modulated variables. Irrespective of the specific design, the electric voltage or the electric current can be used as a controlled variable in a simple control-technical manner.

As an example, while in operating mode, the entire range of functions of the drive arrangement may be available, while in standby mode only minimal functions are available. This may provide a number of advantages such as that the power consumption in standby mode can be kept extraordinarily low. As an example, the standby mode is set up for the fulfillment of a standby condition.

In one or more embodiments, the monitoring routine, but not the holding routine, runs in standby mode. According to another embodiment, the control arrangement may be placed in the operating mode on detection of the predetermined flap deflection and the holding routine is triggered. This results in a particularly energy-saving implementation of the proposed solution.

The consideration that in the proposed holding control circuit the level of the restoring force generated by the drive arrangement to hold the flap can be determined and taken into account. For example, it may be assumed that the restoring force exceeding a predetermined actuation threshold is highly likely to be due to a manual action of the user on the flap. Accordingly, it is provided in an alternative that in this case the holding routine will be exited. Alternatively or additionally, it may be provided that depending on the direction of the restoring force, an adjustment routine such as a closing adjustment or an opening adjustment is triggered. The holding routine is thus used twice as it were, namely on the one hand for the original holding of the flap and on the other hand for the detection of a possible manual force effect of the user on the flap.

Another way to detect a user actuation is that an actuation sensor is associated with the flap. This may further reduce the likelihood of a user holding the flap in an undesired manner.

One or more embodiments relate to equipping the drive arrangement with an active side in the form of a motorized drive and with a passive side in the form of a spring unit. As an example, in the event that the spring unit is a gas pressure spring, aging phenomena are to be expected, which manifest themselves in a reduction of the force of the spring unit. This undesirable reduction of the spring force can be easily detected within the framework of the holding routine, since depending on the aging state of the spring unit the motorized drive has to introduce more or less driving force, usually against gravity, into the flap in order to hold the flap in the holding flap position. On detection of a predetermined reduction of the spring force of the spring unit, an error routine is carried out, may be designed differently. Thus, it is possible to react to an ageing-related reduction of the spring force of the spring unit at an early stage, for example by replacing the spring unit.

A variant which is easy to implement for the detection of the predetermined reduction may be provided. For example, the occurrence of the predetermined reduction of the spring force of the spring unit is detected by a check of the controlled variable in the holding control circuit. For this purpose, an error criterion may be defined, which as it were represents the predetermined reduction of the spring force of the spring unit. This check of the controlled variable is easy to implement since the holding control circuit is already provided for holding the flap.

According to another embodiment, which has independent significance, the control arrangement, which is set up to carry out the method according to the proposal, is claimed as such. This may be realized due to the fact that software which is used to implement the monitoring routine and the holding routine runs on the control arrangement. In this respect, all comments on the first teaching may be referred to.

According to another embodiment, which also has independent significance, the flap arrangement including the flap which can be displaced relative to the vehicle body, with the drive arrangement associated with the flap and the control arrangement for the control of the drive arrangement.

In one or more embodiments, the flap can be pivoted around a horizontal pivot axis, so that the flap weight acts in the closing direction of the flap. In this case, the system friction may be designed so that the flap is held in at least one deenergized intermediate position by means of the adhesive system friction. However, the sliding system friction, which starts after overcoming the adhesive system friction, may not be sufficient for holding the flap. As an example, the flap may be self-holding owing to the system friction, as far as the flap is in a static, i.e. unmoving state. However, once external influences such as a gust of wind, slamming of a door, loading of the motor wheel, folding of a cargo compartment floor or so on initiates a corresponding mechanical impulse into the flap, which leads to the mentioned overcoming of the adhesion system friction and the onset of the sliding system friction, an additional measure is required to hold the flap. According to the proposal, the holding control circuit is available for this purpose without the need for an additional mechanical brake.

### BRIEF DESCRIPTION OF THE DRAWINGS

The invention is explained below in more detail on the basis of a drawing representing only one exemplary embodiment. In the figures

FIG. 1 shows the rear section of a motor vehicle with a flap arrangement according to the proposal,

FIG. 2 shows the drive arrangement of the flap arrangement according to FIG. 1 in a schematic representation and

FIG. 3 shows a method according to the proposal for the operation of the flap arrangement in accordance with FIG. 1.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

A known method of operating a motorized flap is disclosed in DE 10 2012 018 990 A1, which uses such a mechanical brake. The disadvantage of this is the great mechanical complexity.

In the case of window lifters, control measures are known for holding a windowpane in intermediate positions (DE 10 2004 017 110 A1, EP 1 645 710 A1), wherein a control loop which is set up for holding the windowpane is provided. Such windowpanes may be part of the flap arrangement in question by being accommodated by the flap and accordingly moving with the flap. Moreover, the requirements for motorized adjustment and holding of windowpanes are fundamentally different from those of free-swinging flaps. On the other hand, with each adjustment of the flap, the force relationships prevailing for adjustment and holding change. On the other hand, holding a free-swinging flap, which is regularly carried out against the weight of the flap, is a clamping-relevant and hence safety-relevant function, the implementation of which is a challenge in itself in view of the above varying force relationships.

The method according to the proposal is directed to the operation of a motorized flap arrangement 1 of a motor vehicle, wherein the flap arrangement 1 has a flap 4 that can be pivoted relative to a car body 3. The flap 4 can be pivoted around a pivot axis 4a, the position of which may be fixed or variable relative to the car body 3. Moreover, the term “flap” must be understood broadly in the present case. In addition to pivotable tailgates, trunk lids, front hoods, and engine hoods, it also includes pivotable side doors.

The flap axis 4a of the flap 4 may be horizontally aligned in the exemplary embodiment shown, so that the weight force of the flap 4 acts at least over an adjustment range of the flap 4 in its closing direction.

The flap arrangement 1 has a reversible drive arrangement 5 for motorized adjustment of the flap 4. The flap arrangement 1 further has a control arrangement 6 for the control of the drive arrangement 5. The control arrangement 6 can be associated exclusively with the drive arrangement 5, which corresponds to a decentralized control concept. As an example, it may also be provided that the control arrangement 6 is associated at least in part with a higher level motor vehicle controller.

First of all, a deflection of the flap from a deenergized intermediate position of the flap 4, may be caused by gravity, is detected by means of the control arrangement 6 in a monitoring routine 7.

In one or more embodiments, upon detection of the predetermined flap deflection a holding routine 8 is triggered, in which the drive arrangement 5 is controlled to a holding flap position in a holding control circuit. This two-stage procedure by means of the monitoring routine and by means of the holding routine following the monitoring routine allows on the one hand a modular design from a control point of view, in which the monitoring routine 7 can be housed in a first control module, in particular in a first software module, and the holding routine 8 can be housed in a second control module, in particular in a second software module. In addition, as explained, the monitoring routine 7 can run in a power saving standby mode. Finally, the solution according to the proposal leads to safe holding of the flap 4 in intermediate positions without the need for a mechanical brake.

With the exemplary embodiment shown in the drawing, the drive arrangement 5 has a first drive 9 and a second drive 10, which act on opposite sides of the flap 4. As an example, the drives 9, 10 are spindle drives. However, all other types of drives can be used here.

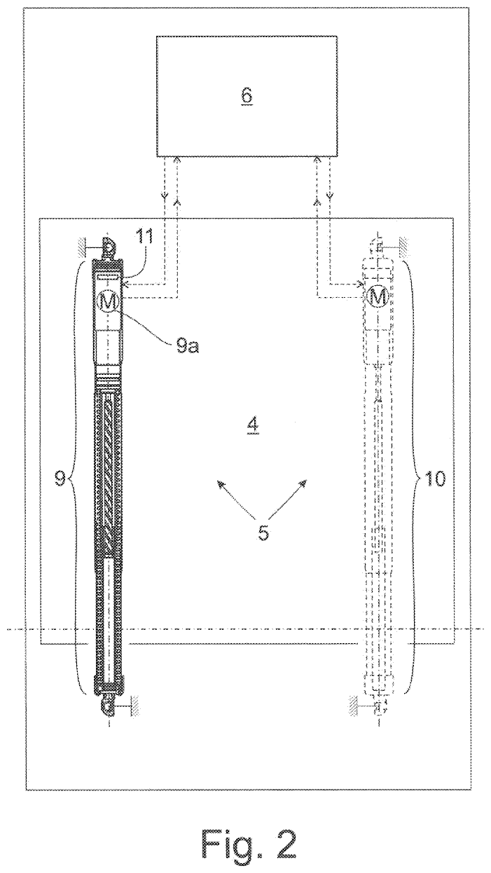

In principle, it may be provided that in the holding routine 8 both drives 9, 10 are controlled to the holding flap position. As an example, however, it is the case that only one of the two drives 9, 10, here the drive 9 shown on the left in FIG. 2, is controlled to the holding flap position. Therefore, reference is always made below to the drive 9. All these implementations apply to the further drive 10 accordingly.

For the definition of the holding-flap position various advantageous variants are conceivable. In one or more embodiments, the holding flap position is defined as the intermediate position from which the predetermined flap deflection has taken place. For example, it may be provided that the control arrangement 6 stores the flap position continuously, so that in the state of the deenergized intermediate position a value for the intermediate position is stored in the memory of the control arrangement 6. Based on this, the drive arrangement 5 can then be controlled to the intermediate position in the holding routine.

However, it may also be advantageous that the holding flap position is the deflected flap position. This is advantageous in so far as no possibly surprising return movement of the flap 4 takes place during the holding routine.

In order to prevent accidental triggering of the holding routine, the predetermined flap deflection which triggers the holding routine must be defined in a suitable manner. As an example, the predetermined flap deflection is a deflection of the flap 4 away from the respective intermediate position by a predetermined minimum flap displacement distance. Alternatively or additionally, the predetermined flap deflection may also be defined by a minimum flap speed and/or a minimum flap acceleration.

For the detection of the predetermined flap deflection, the generator voltage of a drive motor 9a of the drive arrangement 5, which results in the reverse drive of the drive train of the drive arrangement 5, can be advantageously used. The generator voltage can in principle also be used to supply at least a part of the control arrangement 6 with an electric voltage until the control arrangement 6 has been awakened in a way which is yet to be explained.

Alternatively or additionally, it may be provided that the sensor signal of a sensor 11 associated with the drive arrangement 5 is monitored in the monitoring routine for detection of the predetermined flap deflection.

The holding control circuit is a control circuit with a feedback strand, which can also be cascaded in principle. The control variable of the holding control circuit may be the holding flap position, while the controlled variable of the holding control circuit may be the electric voltage and/or the electric current of at least one drive motor 9a of the drive arrangement 1. The control -related details of such a control circuit as such are known from the prior art.

The control arrangement 6 may include a driver unit for connecting the drive arrangement 5 to electric drive power. Here, for example, the usual bridge circuits, in particular H-bridge circuits, can be used. Furthermore, the control arrangement 6 is equipped with a logic unit for controlling the driver unit. The logic unit can also serve other purposes. For example, the logic unit can verify the authentication of the operator when opening the flap 4.

In the sense of a power-saving operation, it may be provided that the control arrangement 6 is brought from an operating mode into a standby mode with a flap 4 located in an intermediate position for the fulfilment of a standby condition. The standby mode is defined here and may be in such a way that the monitoring routine 7 is running, but not the holding routine 8. In an exemplary embodiment, in standby mode all power-consuming functions of the control arrangement 6 are deactivated, insofar as these are not needed for awakening the control arrangement 6 from the standby mode.

The standby condition may be the condition during a predetermined standby period, without motorized control of the drive arrangement 5 being carried out. Other variants for the definition of the standby condition are conceivable.

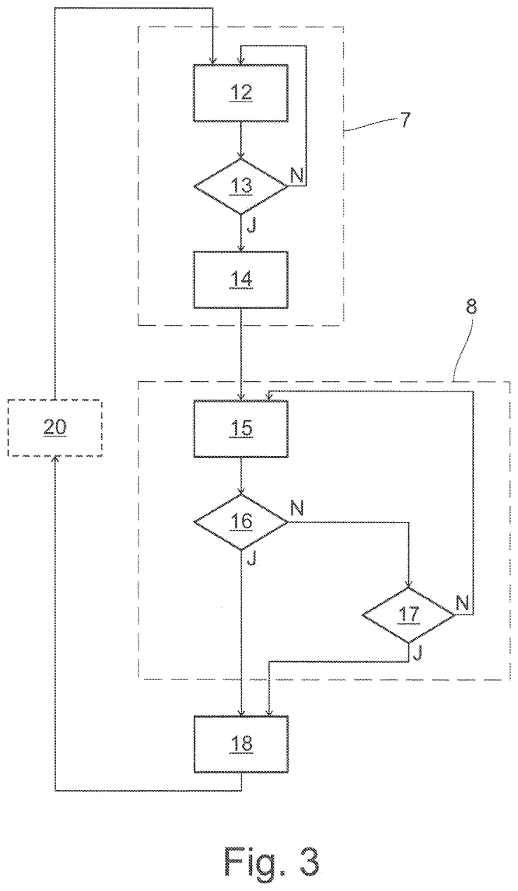

As an example, the control arrangement 6 is brought into the operating mode for the detection of the predetermined flap deflection, after which the triggering of the holding routine 8 follows. This can be seen in the representation according to FIG. 3.

Within the monitoring routine 7 shown schematically in FIG. 3, a monitoring step 12 takes place first, in which it is checked whether a flap deflection has taken place at all. This can be carried out, for example, based on the sensor signal of the sensor 11. In the comparison step 13, it is checked whether the detected flap deflection meets the criteria for a predetermined flap deflection. If this is not the case, a return to the monitoring step 12 takes place. If the detected flap deflection meets the criteria for the predetermined flap deflection, the wake-up step 14 is triggered, which includes the transfer of the control arrangement 6 from the standby mode to the operating mode.

Subsequently, the holding routine 8 shown in FIG. 3 is triggered, in which the controller 15 is triggered to the holding flap position. In the course of the control, a value for the restoring force generated by the drive arrangement 5 may be determined. In order to ensure that no excessive, clamping-relevant forces act, the holding control circuit may be designed in such a way that the value of the restoring force is limited to a predetermined restoring force limit value.

Various advantageous variants are conceivable for determining the restoring force. As an example, it is the case that the respective restoring force is concluded from the electric voltage and/or the electric current of at least one drive motor 9a of the drive arrangement 5 based on an electric drive model of the relevant drive motor 9a. In principle, the values for voltage and/or current can correspond to or be derived from the above-mentioned controlled variable.

The special advantage of determining a value for the restoring force is that a user request directed to an adjustment of the flap 4 can be detected, which manifests itself in a force effect on the flap 4 on the part of the user. For this purpose, the restoring force is checked by means of the control arrangement 6 in a comparison step 16 to determine whether a predetermined actuation threshold is exceeded by the restoring force. If the actuation threshold is exceeded by the restoring force, the holding routine 8 may be exited. This primarily ensures that the control arrangement 6 with the holding routine 8 does not work against the user.

Alternatively or additionally, an adjustment routine 18 can be triggered, as can be seen from the diagram according to FIG. 3. In the adjustment routine 18, such as a motorized adjustment of the flap 4, or a motorized closing adjustment to the closing position of the flap 4 or a motorized opening adjustment to the open position of the flap 4, is effected in an adjustment direction opposite to the restoring force. Thus, if the user pushes the flap 4 in the closing direction, a restoring force is first generated in the holding routine 8 which opposes the force effect of the user. If the restoring force exceeds the actuating threshold, the control arrangement 6 follows the user request by corresponding control of the drive arrangement 5 with a motorized adjustment of the flap 4 in the closing direction.

Further alternatively or additionally, it is conceivable that the user expresses a request for adjustment of the flap 4 in another way. This can be provided, for example, by operating a radio remote control. For this purpose, the comparison step 16 is followed by another query step 17 directed towards querying a possible user request, which in turn can lead to the triggering of the adjustment routine 18.

In order to avoid, as mentioned above, the holding routine 8 working against the user's request, an actuation sensor 19 is associated with the flap 4 for the detection of a user actuation. In this context, it is intended that on detection of a user actuation the holding routine 8 will be exited and/or an adjustment routine 18 which is explained above will be triggered. As an example, the actuation sensor 19 is a proximity sensor for detecting a user movement. Alternatively, the actuation sensor 19 can be a force sensor for the detection of a user force action on the flap 4, in particular a manual force applied to the flap 4 by the user.

The transfer of the control arrangement 6 back to the standby mode can be provided in different ways. In FIG. 3 this is provided, for example, after completion of the adjustment routine 18 as indicated by the reference character 20.

It has already been mentioned above that the drive arrangement 5 may comprise one motor drive 9, 10 or two motor drives 9, 10. In one or more embodiments, it is provided that the drive arrangement 5 has a drive 9 for motorized adjustment of the flap 4 and that the drive arrangement 5 has a deflecting spring unit separately designed from the drive 9 for the introduction of a spring force into the flap 4, such as a gas pressure spring unit. The spring unit may be used to support the motor drive 9 against gravity.

As also mentioned above, the spring unit is subject to aging behavior, in particular if the spring unit is a gas pressure spring unit. This aging behavior may be detected by means of the control arrangement 6. As an example, the case that a predetermined, such as an age-related, reduction of the spring force of the spring unit, or a reduction of the spring force of the spring unit to below a spring force limit, is detected by means of the control arrangement 6 in the holding routine and thereafter an error routine is carried out. In this case, the spring force limit is may be dependent on the flap position and/or on the spring deflection travel of the spring unit.

Numerous advantageous variants are conceivable for the design of the error routine. In one or more embodiments, a warning message regarding the aging state of the spring unit is issued via a display device in the error routine. Alternatively or additionally, it is provided that an error memory is set with respect to the aging state of the spring unit in the error routine.

Since the reduction of the spring force of the spring unit cannot easily be detected directly, an indirect approach may be used, in which the above-mentioned controlled variable of the holding control circuit is checked. As an example, in the holding routine the actuator in the holding control circuit is checked for the fulfilment of an error criterion by means of the control arrangement 6 for detection of the predetermined reduction of the spring force of the spring unit. In this case, the error criterion may be defined as the controlled variable or a time average of the controlled variable exceeding a controlled variable limit. The controlled variable limit further may be based on that of the flap position and/or on an inclination of the motor vehicle 2 and/or on an ambient temperature of the motor vehicle 2. These dependencies can easily be determined experimentally and stored in a memory of the control arrangement 6. The age of the spring unit can also be taken into account, for example to avoiding a slowly aging, but still sufficiently functional spring unit leading to setting of the above error memory.

According to another embodiment, which has independent significance, the control arrangement 6 is claimed as such for the implementation of the above method according to the proposal. It has already been pointed out that the control arrangement 6 may include software that maps the method according to the proposal.

According to another embodiment, which also has independent significance, the flap arrangement 1, which is set up to perform the method according to the proposal, is claimed as such. The flap arrangement 1 accordingly has a flap 4 which is adjustable relative to the motor vehicle body 3. Furthermore, the flap arrangement 1 is equipped with a drive arrangement 5 which is associated with the flap 4 and an above control arrangement 6.

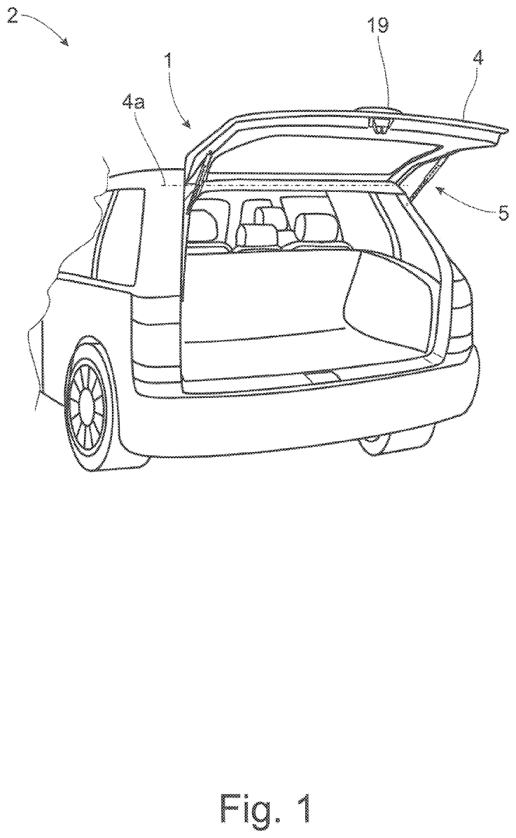

In the exemplary embodiment shown in FIG. 1, the flap 4 is pivotable around a horizontal pivot axis 4a, which, as mentioned above, may be fixed or adjustable relative to the car body 3. Accordingly, the gravitational force pushes the flap 4 in the closing direction, as has also been explained.

The system friction, i.e. the friction which must be overcome for an adjustment of the flap 4, is designed so that at least in the normal state, the flap 4 is held by means of the adhesive system friction in at least a deenergized intermediate position, such as in all positions. In at least another embodiment, however, it is the case that the sliding system friction which occurs after overcoming the adhesive system friction is insufficient for holding the flap 4, in particular compared to the weight force of the flap 4. This is the time at which the holding routine 8 is triggered to detect the predetermined flap deflection. Holding the flap 4 is therefore carried out as mentioned purely by control means, without the need for a mechanical brake.

The normal state is defined here and preferably such that the motor vehicle 2 is located in an inclined position, which corresponds to a road gradient within +/−40%, preferably +/−30%. Outside the normal state, i.e. with an exceptionally steep slope, it may be that holding the flap 4 in any position is carried out purely by control means, since the adhesive friction may not be sufficient for holding the flap 4.

The following is a list of reference numbers shown in the Figures. However, it should be understood that the use of these terms is for illustrative purposes only with respect to one embodiment. And, use of reference numbers correlating a certain term that is both illustrated in the Figures and present in the claims is not intended to limit the claims to only cover the illustrated embodiment.

### PARTS LIST

1 flap arrangement
2 motor vehicle
3 car body
4 flap
5 drive arrangement
6 control arrangement
7 monitoring routine
8 holding routine
9 first drive
10 second drive
11 sensor
12 monitoring step
13 comparison step
14 wake-up step
15 controller
16 comparison step
17 query step
18 adjustment routine
19 actuation sensor
20 reference character
4a pivot axis
9a one drive motor

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A method of operating a motorized flap arrangement of a motor vehicle, the flap arrangement including a flap is pivotable relative to a car body, a reversible drive arrangement configured to provide motorized adjustment of the flap, and a control arrangement configured to control the drive arrangement, the method comprising:
moving the flap from or to a deenergized intermediate position;
executing a monitoring routine, by the control arrangement, to detect
a predetermined flap deflection; and
triggering a holding routine, by a holding control circuit, to hold the flap in a holding flap position.

2. The method of claim 1, wherein the drive arrangement includes two drives, and the holding routine includes controlling the two drives, or a first drive of the two drives, to hold the flap in the flap position.

3. The method of claim 1, wherein the flap position is the deenergized intermediate position, or flap position is a deflected flap position.

4. The method of claim 1, wherein the predetermined flap deflection is based on a deflection of the flap from the intermediate position by a predetermined minimum flap adjustment distance and/or at a minimum flap speed and/or at a minimum flap acceleration.

5. The method of claim 1, wherein the executing step includes monitoring a generator voltage of a drive motor of the drive arrangement and/or a sensor signal from a sensor of the drive arrangement to detect the predetermined flap deflection.

6. The method of claim 1, wherein the triggering step includes receiving a control variable of the holding control circuit and a controlled variable of the holding control circuit, wherein the control variable of the holding control circuit is the holding flap position, and the controlled variable of the holding control circuit is the electric voltage and/or the electric current of at least one drive motor of the drive arrangement.

7. The method of claim 1, further comprising:
changing the control arrangement from an operating mode to a standby mode to satisfy a standby condition in response to the flap being in the deenergized intermediate position, wherein the standby condition takes place during a predetermined standby period without motorized control of the drive arrangement.

8. The method of claim 7, wherein the control arrangement changes to the operating mode to detect the predetermined flap deflection.

9. The method of claim 1, wherein the holding routine includes determining a value for a restoring force generated by the drive arrangement.

10. The method of claim 9, further comprising:
checking, by means of the control arrangement, determining whether the restoring force exceeds a predetermined actuation threshold, and responsive to the restoring force exceeding the predetermined actuation threshold, exiting the holding routine and/or triggering motorized adjustment of the flap.

11. The method of claim 1, further comprising:
detecting, by an actuation sensor, a user actuation;
exiting the holding routine; and/or
triggering an adjustment routine, the adjustment routine includes providing motorized closing adjustment of the flap or motorized opening adjustment of the flap.

12. The method of claim 1, further comprising:
executing an error routine, in response to a spring force of a spring unit of the drive arrangement falling below a spring force limit.

13. The method of claim 12, wherein the executing an error routine includes:
issuing a warning message, by a display device, in response to the spring force of the spring unit falling below the spring force limit.

14. The method of claim 13, wherein the holding routine includes,
checking, by means of the control arrangement, the spring force of the spring unit whether an error criterion is satisfied, the error criterion is based on controlled variable or a time average of the controlled variable exceeding a controlled variable limit.

15. (canceled)

16. A flap arrangement including a flap and a drive arrangement configured to move the flap relative to a motor vehicle body, the flap arrangement comprising:
a control arrangement configured to, responsive to the flap moving to or from an intermediate position, execute a monitoring routine to detect a predetermined flap deflection; and
a holding control circuit configured to hold the flap in a holding flap position.

17. The flap arrangement of claim 16, wherein the flap is pivotable about a horizontal pivot axis.

18. The flap arrangement of claim 16, wherein the system friction is designed so that the flap is held by means of the adhesive system friction in at least one deenergized intermediate position.

19. A flap arrangement for use in a vehicle provided with a vehicle body, the flap arrangement comprising:
a flap configured to pivot with respect to the vehicle body;
a drive arrangement including a motor configured to actuate to pivot the flap between a closed position and an open position; and
a controller configured to actuate the motor to stop deflection of the flap, responsive to,
a cessation of power to the drive arrangement,
the flap positioned in an intermediate position, disposed between the closed position and the open position, and
detection of the deflection of the flap.

20. The flap arrangement of claim 19, further comprising:
a sensor configured to measure an acceleration of the flap, wherein the controller is further configured to cease power to the drive arrangement in response to the acceleration of the flap exceeding a threshold.

21. The flap arrangement of claim 19, further comprising:
a display device, wherein the controller is further configured to actuate the display device to display a warning message in response to the detection of the deflection of the flap.
